(19) United States
(12) Patent Application Publication
(10) Pub. No.: US 2019/0041035 A1
(43) Pub. Date: Feb. 7, 2019

(54) LIGHTING DEVICE WITH SPARKLING EFFECT

(71) Applicant: PHILIPS LIGHTING HOLDING B.V., EINDHOVEN (NL)

(72) Inventors: Durandus Kornelius DIJKEN, EINDHOVEN (NL); Silvia Maria BOOIJ, EINDHOVEN (NL); Elise Claude Valentine TALGORN, EINDHOVEN (NL); Bas BATENBURG, EINDHOVEN (NL); Johannes Maria THIJSSEN, EINDHOVEN (NL); Hermanus Wilhelmus Maria VAN DELDEN, EINDHOVEN (NL)

(21) Appl. No.: 16/076,364

(22) PCT Filed: Feb. 17, 2017
(86) PCT No.: PCT/EP2017/053670

§ 371 Date: Aug. 8, 2018

(30) Foreign Application Priority Data
Feb. 26, 2016 (EP) 16157502.2

(51) Int. Cl. F21V 11/14; F21V 11/16

(52) U.S. Cl. CPC F21V 11/14; F21Y 2107/60; F21V 11/16

(57) ABSTRACT

The invention provides a lighting device configured to present to an observer a spatially dynamic sparkling light dis play. The device comprises a luminaire containing a plurality of light sources (28) located on a first surface portion, and arranged to direct light in a direction of a plurality of light transmissive areas (32) formed within an opposing second surface portion. The opposing second surface portion may at least partially bound a chamber (14) within which the primary light sources are disposed, where an internal surface arrangement of the chamber is configured to absorb at least part of the spectral composition of any light emitted by the primary light sources which does not fall directly onto the light transmissive areas.

### FIELD OF THE INVENTION

The present invention relates to a lighting device providing a visually appealing lighting effect, in particular, a dynamic sparkling or glittering effect. The lighting device can for example be used in a lighting display or installation.

### BACKGROUND OF THE INVENTION

Dynamic lighting in nature can be a bewitching experience. Consider, for example, sunlight refracted by water droplets or reflected on the moving sea surface, erratic star light, or sunlight blocked sporadically by the trembling leaves of a tree.

Lighting designers often seek to recreate this striking effect of dynamic lighting in time and space. Dynamic lighting in time is easily realised through individually addressing LEDs within an LED ensemble. Dynamic lighting in space—a variation in light intensity depending on the viewer position—is often achieved through the use of glittering particles, lead glass crystals, or, in more complex solutions, through mechanisms that spatially displace the LED or optics. The effect created by dynamic lighting in space is commonly called glittering, or sparkling.

Glittering as a decorative effect is frequently used in architecture and in interior design, to provide a high end finish to walls or ceilings. It is visually appealing, and can provide a sense of luxury or glamour. Most standardly, glittering is achieved by reflecting light onto specularly reflective particles or by transmitting light through lead glass crystals.

This is usually achieved through applying glittering particles or lead glass crystals onto a surface, and using the reflection of light which is emitted by light sources installed at a distance from the surface. In this case, however, the light source must be installed as a separate component, which is aesthetically invasive and more burdensome and complex to install.

An alternative solution is to install the lead glass crystals into a panel, and to mount the light source(s) directly onto the back of them. Here, the light source remains hidden and the whole apparatus can be provided in a single, unitary panel.

However, use of lead glass crystals to achieve sparkling is not ideal. The crystals are generally expensive and heavy, and mounting them into a panel in order to realise the solution described is far from trivial.

GB2243223A discloses an illumination device designed to simulate the night sky. The device comprises a lighting panel having a front plate appertured with holes, and which contains a plurality of conventional light sources, arranged to direct light toward said front plate. Between each of the light sources is positioned a wing reflector element, these elements are provided in order to project a maximum amount of light possible through the apertures of the front plate. To an observer looking at the panel from outside, an effect is created similar to that of a starry night sky. However, in this solution, the light sources remain visible through the apertures in the front plate over all angles. As a result, a true (spatially dynamic) sparkling effect, in which point sources across the display give the impression of disappearing and appearing briskly as one changes position, is not created.

U.S. Pat. No. 2,861,173 also discloses a lighting device for creating an effect similar to that of a starry night sky. The lighting device has a plurality of lamps, each located in a housing that is provided in a top surface of a top plate. Clamped to a bottom surface of the top plate are an inner screen and an outer screen, arranged in parallel and spaced apart from each other. The inner screen may a metallic inner screen, having a plurality of spaced apart punched holes, wherein the surface facing the outer screen is at least nearly specularly reflective by being highly polished or painted with a white gloss. The spaced apart punched holes allow beams of light to pass through the inner screen, and to project a plurality of light spots on the outer screen. The outer screen is made from a light-diffusing material, such as cloudy plastic, and the light spots can be viewed from any angle with respect to the lighting device. Again, a true (spatially dynamic) sparkling effect, in which point sources across the display give the impression of disappearing and appearing briskly as one changes position, is not created.

There is a need in the art therefore for a lighting device capable of creating a true spatially dynamic sparkling light effect, but which is more compact than solutions requiring light sources to be installed at a distance from a sparkling panel, and which is cheaper, lighter and simpler than alternative lead glass panel solutions.

### SUMMARY OF THE INVENTION

The invention is defined by the claims.

According to a first aspect of the invention, there is provided a lighting device for providing a dynamic sparkling or glittering effect. The lighting device comprises an exposed outer surface and a plurality of primary light sources disposed within a chamber. The chamber has an internal surface arrangement including at least a first surface portion, and an opposing second surface portion The plurality of primary light sources is located on the first surface portion, and the second surface portion comprises a plurality of light-transmissive areas.

Each primary light source is arranged to illuminate at least a part of the plurality of light-transmissive areas in order to create a plurality of secondary light sources. The plurality of secondary light sources is located on the exposed outer surface of the lighting device, and each of the plurality of secondary light sources has a light-emitting surface with an anisotropic luminance.

Each primary light source is adapted to emit light of a particular spectral composition, and the internal surface arrangement of the chamber is configured to absorb at least a portion of the spectral composition of the light emitted by the primary light sources onto the internal surface arrangement other than the light transmissive areas.

In the context of the present invention, an exposed outer surface is a surface that is at the outside of the lighting device and that is directly observable by an observer. This means that when an observer is looking in a direction towards the exposed outer surface he can observe the exposed outer surface without the interference of any other component of the lighting device. Because the plurality of secondary light sources is located on the exposed outer surface of the lighting device, these secondary light sources are also directly observable by an observer. An observer looking in a direction towards the exposed outer surface can observe the light-emitting surface of each secondary light source without the interference of any other component of the lighting device.

Each of the plurality of secondary light sources has a light-emitting surface with an anisotropic luminance. The term “luminance” denotes the luminous intensity per unit area of light travelling in a given direction. The luminance indicates how much luminous power will be detected by an observer looking at the light-emitting surface from a particular angle of view. Luminance is thus an indicator of how bright the light-emitting surface will appear (the term “brightness” being typically used to refer to the subjective impression of luminance). When the luminance of a light-emitting surface is anisotropic, the apparent brightness of the light-emitting surface depends on the observer's angle of view.

In the context of the present invention, a light source can be a “real” light source or a “virtual” light source. The aforementioned secondary light sources that are created upon illumination of light-transmissive areas in the second surface portion are virtual light sources. The primary light sources can be real or virtual light sources.

In operation, the aforementioned lighting device creates for an observer an effect of light sources that significantly diminish or alter in intensity or spectral composition across a range of different positions relative to the lighting device.

Each of the real or virtual primary light sources that is located on the first surface portion creates a plurality of virtual secondary light sources on the exposed outer surface of the lighting device. When looking at the exposed outer surface of the lighting device, and dependent on the position relative to the exposed outer surface, an observer will either have a direct line of sight with the primary light source that creates the plurality of secondary light sources, or no direct line of sight with the respective primary light source.

The plurality of secondary light sources created by a primary light source ideally emits light in alternately spaced angular ranges, being a plurality of angular ranges or angular distributions that are non-overlapping and also non-adjacent, or non-proximate. In other words, the angular ranges or angular distributions wherein light is emitted by the secondary light sources are interspaced with regions wherein no light (or at least significantly less light) is emitted by the secondary light sources, thereby forming a discontinuous distribution of light.

When the observer is within an angular range wherein light is emitted by the secondary light sources, he has a direct line of sight with the primary light source that creates the plurality of secondary light sources when he is looking in the direction of the lighting device. When the observer is within a region wherein no light is emitted by the secondary light sources, he has no direct line of sight with the respective primary light source.

Under such an arrangement, when a primary light source, light transmissive area and observer eye are all in alignment, the full spectral composition of the light emitted by the primary light source falls incident at the observer's eye, and the observer perceives, emanating from the position of the light transmissive window area, a bright light point of high intensity. If the observer moves his position slightly, such that said alignment is broken, at least part of the spectral composition of the light from the respective primary light source ceases to fall incident at his eye and the bright light spot gives the appearance of vanishing from view, or at least significantly diminishing in intensity or altering spectral composition. When replicated across the whole front surface of the device, an effect is created for an observer of almost instantaneously appearing and disappearing bright light sources, occurring across a wide range of different positions across the device, and set against a comparatively dark or dim background, or at least a background which has a different spectral composition to the light creating the sparkle effect. In this way, a true spatially dynamic sparkling light effect is created.

To maximise the effect, it is necessary to ensure that misalignment of any primary light source, light transmissive area and oberver's eye leads directly to the perception of a total, or near total, disappearance of the primary light source from view. It is in this way that true sparkling is achieved, as opposed to a mere isotropic display of point light sources (as described with reference to the prior art above). This in turn requires a sufficiently strong intensity difference, or contrast ratio, to be present between any virtual secondary light source represented by an appropriately aligned light-transmissive area, and the surrounding surface area of the exposed outer surface of the lighting device.

To achieve this, the present invention provides the primary light sources disposed within a chamber bounded, or partially bounded, by one or more internal surfaces configured to at least partially absorb any light not falling directly onto the light transmissive areas. The effect of this is to ensure that any light which is emitted from the device indirectly (via reflection for example) has an intensity or spectral composition which is reduced compared to light emitted directly by the primary light sources through the light transmissive areas. This ensures that a sufficiently sharp contrast is created for an observer between the directly aligned primary light sources, and the remainder of the non-aligned transmissive areas.

According to some embodiments, the internal surface arrangement is configured to absorb the full spectral composition of the light. In this case, internal surfaces of the chamber are configured to absorb substantially all of the light not falling directly incident on the light transmissive areas. This hence prevents any (secondary) reflection of light within the chamber itself and effectively prevents all indirect escape of light from the device. This provides the maximal intensity contrast between aligned primary light sources and non-aligned light-transmissive areas (and the surrounding surface area of the front of the device).

However, in alternative embodiments, the internal surface arrangement may be adapted to absorb only a portion of the spectral composition of the light. In this case, some secondary reflection of light not falling directly incident on the light-transmissive areas is able to occur, but not in an unaltered state. Rather the walls are configured to absorb part of the spectral composition, so that the reflected light has a different composition to the incident light. In the case of any such reflected light which escapes the device therefore, there remains a significant degree of apparent contrast between directly emitted light and indirectly emitted light which extends beyond any intensity difference brought about via the partial absorption by the internal surface(s).

In embodiments, a spectral composition of light may refer to a spectral profile of the light, meaning the composition of component frequencies of radiation which form the light. In examples, the light may have a spectral composition which comprises one or more frequency components falling outside of the visible spectrum. In some cases, spectral composition may imply a particular colour of light, or may imply light that is a combination of colours, such as white light of a particular colour temperature.

In examples in which the internal surface arrangement is configured to absorb only part of the spectral composition of light emitted by the primary light sources, the arrangement may have the effect of changing the apparent colour or colour temperature of the light, i.e. the walls of the chamber reflect light of a different colour to that which is emitted by the primary light sources. The internal surface arrangement may for example comprise one or more internal surfaces which are tinted or shaded or otherwise coloured (these words intended in their ordinary, conventional sense) such that they reflect only certain frequencies of electromagnetic radiation.

According to one or more embodiments, the first surface portion may be adapted to absorb at least a portion of the spectral composition of the light falling incident on it. However, in other embodiments, the first surface portion may not be absorptive in this way. For example, where primary light sources are used which are adapted to emit light over an angular range which does not exceed 180°, it is possible to achieve even complete curtailment of secondary reflection of light, so long as every internal surface of the internal surface arrangement which does fall within said 180° range is appropriately absorptive. In such a case, the first surface portion, although not adapted to absorb, nonetheless cannot be a source of secondary reflections, since none of the emitted light is able to reach it, either directly from the primary light sources, or indirectly via reflections from other internal surfaces.

According to any embodiment of the invention, the internal surface arrangement may comprise a single internal surface or a plurality of internal surfaces. The internal surface arrangement refers to the arrangement formed by the totality of internal surfaces of the chamber. In some cases, for example, the device might comprise a spherically or elliptically bounded chamber (or a similar non-regular variant shape), wherein the internal surface arrangement may comprise just a single continuous internal surface formed by the inner surface of the outer shell or structure bounding the spherical chamber.

In other cases, however, the chamber might for example comprise a panel or box-shape chamber, wherein the internal surface arrangement comprises a plurality of internal surfaces. The device may in this case for example comprise a panel, having a back plate, a front plate and side walls which together bound the chamber.

In either of the above described cases, the internal surface arrangement may in some examples comprise only the inner surfaces of the outer bounding structure or shell of the chamber, or may further comprise additional, auxiliary surfaces formed disposed within the chamber itself.

In examples, the surface portions may constitute regions, areas or sections of one or more broader surfaces. However, in other examples, they may constitute a unitary (single) surface in their own right. For example, where the device comprises a spherically or elliptically bounded chamber (or a similar but non-regular variant shape), the second surface portion may comprise a portion, section, region or area of the internal or inside surface of a spherical shell or casing bounding the chamber. In this case, the first surface portion might comprise an opposing region of the internal surface of said spherical casing, or might alternatively comprise part or all of an auxiliary or additional surface element disposed within the chamber, for example close to, or at, the centre of the spherical chamber defined by the outer spherical casing.

However, where the device comprises for example a panel-like construction, having a cuboidal shaped chamber, the second surface portion may constitute the entirety of a front panel of the structure or frame bounding the chamber. In this case, the first surface portion might comprise the entirety of a back panel element of the structure or frame bounding the chamber.

In this or other examples, the first surface portion may comprise the whole or a part of an inner surface of a wall of panel partially or fully bounding the chamber, or may alternatively, comprise the whole or a part of an auxiliary surface within the chamber, for example a dedicated mounting surface.

According to one or more examples of the present invention, the light transmissive areas may comprise holes, apertures or openings in the opposing surface portion, or may alternatively comprise window elements being formed of a light transmissive material.

Ideally, the chamber is completely bounded or sealed apart from the light transmissive areas of the opposing surface portion. In this way, maximal protection is afforded from ingress of unwanted external, environmental light, where it may interfere with the optical operation of the device. In addition, this provides maximal protection against unwanted escape of light from the chamber which might diminish or weaken the contrast ratio between illuminated light transmissive areas (from the perspective of an observer) and the surrounding surface area of the front panel or surface.

In examples, the internal surface arrangement may be configured to fully absorb at least a portion of the spectral composition of light emitted by the primary light sources. In other examples, the internal surface arrangement may be configured to partially absorb all or part of the spectral composition of the light emitted by the primary light sources. In either case, the arrangement is such as to ensure that any secondary reflected light which does exit the chamber is reduced in one or both of its intensity or spectral composition before it is able to do so.

According to one or more embodiments, the lighting device may comprise at least a first portion of primary light sources adapted to emit light of a first spectral composition, and at least a second portion of primary light sources adapted to emit light of a second spectral composition. The lighting device may further comprise one or more optical elements together adapted to direct light emitted by the at least first portion of primary light sources through the light transmissive areas of the opposing surface portion at a first range of propagation angles, and to direct light emitted by the at least second portion of primary light sources through the light transmissive areas at a second range of propagation angles.

In these examples, an observer may observe light of a first colour when looking at the device from a first range of angles relative to the device, and may perceive light of a different colour when looking from a second range of angles relative to the device. When an observer changes their position relative to the device, they may observe the first colour when moving and facing in a first set of directions relative to the device, and may observe the second colour when moving and facing in a second set of directions relative to the device.

In some examples of the above embodiment, the optical elements may comprise light blocking elements adapted to deflect or absorb at least a portion of the light emitted by the at least first and/or second portion of primary light sources. These elements together provide the effect of directing light of the first spectral composition through light transmissive areas across the first range of propagation angles, and directing light of the second composition across the second range of angles.

Additionally or alternatively, in some examples the at least first portion of primary light sources may be arranged at a first distance from the opposing surface portion, and the at least second portion of primary light sources may be arranged at a second distance from the opposing surface portion, wherein the optical elements are disposed in-between the first and second portions of primary light sources.

In this case, the first range of angles may comprise the second (or vice versa), i.e. the second range lies within the first. Here, the portion closer to the light transmissive areas may emit light across the broader first range of angles, and the furthermost portion, may emit light which, by means of the optical elements, is directed through the light transmissive areas only across a narrower range of angles. The effect of this is that over said narrower range of angles, an observer may perceive light of two differing colours (corresponding to both the first and second spectral compositions), and over the remaining angles, may perceive light only of the second or first colour.

In any of the above examples, the primary light sources may alternatively comprise more than two portions of spectrally differing light sources, for example three or more portions of light sources, each portion comprising sources adapted to emit light having a spectral composition different from the other portions.

Furthermore, in examples of the above or any other embodiment, one or more of the primary light sources may be adapted to individually emit light having a first spectral composition across a first range of propagation angles, and to emit light having a second spectral composition across a second range of propagation angles. Alternatively, said one or more primary light sources may not emit the different spectral compositions at different angles, but may simply be adapted to emit light of the first composition across a first portion of a light emitting surface and light of the second composition across a second portion of a light emitting surface. The different spectral compositions may imply light of differing colours. In either of the above cases, said one or more of the primary light sources may be adapted to emit light exhibiting a colour gradient.

In particular examples, one or more of the primary light sources may comprise a single light emitting element adapted to emit light of more than one colour, or may comprise a light source having multiple individual elements configured to operate co-operatively to produce light of more than a single colour. In either case, these multiple colours may be generated singly (in isolation), or simultaneously with one another. In certain examples, one or more of the primary light sources may comprise an RGB LED and/or may comprise a co-operative assembly of one or more of each of an R LED die, a G LED die and a B LED die. In examples, the intensity of each LED die or light source may be individually adjustable and/or each individual LED of a multiple LED light source (for instance) may be individually addressable.

In one or more embodiments, the primary light sources may each have a respective optical axis, and the light transmissive areas may be formed or arranged such that none lie on any of said respective optical axes. For example, the primary light sources may be arranged at positions laterally displaced from the positions of the light transmissive areas, where laterally displaced means displaced in a direction parallel with the opposing surface portion.

In this way the elements may be arranged such that an observer looking directly through a light transmissive area is unable to see the arrangement or pattern of primary light sources disposed within the chamber. This adds to the overall aesthetic effect of the lighting device, which is to provide to an observer, on moving past the device, a sparkling effect which is surprising and mysterious, where the source of the glittering lights remains obscure.

According to one or more embodiments, the lighting device may further comprise light blocking elements disposed within the chamber, arranged to coincide with and at least partially cover the light transmissive window elements of the opposing surface portion, so as to block the escape of light through the transmissive areas across one or more ranges of propagation angles.

In examples, the lighting device may comprise a first pattern of light transmissive areas and a second pattern of primary light sources, the second pattern being different to the first. In this way, the light transmissive areas and the primary light sources may be respectively arranged so as to not align or coincide with one another, thereby helping to keep the arrangement of primary light sources hidden from an observer.

In some cases, the second pattern may be an irregular pattern, for example a random or semi-random pattern. By utilising an irregular or semi-random pattern, greater freedom is afforded in the arrangement or configuration of the light transmissive areas, since these may (theoretically) be configured according to any desired pattern, while substantially avoiding alignment with the primary light sources.

According to one or more embodiments, the lighting device may further comprise one or more light sensor elements arranged in proximity to the second surface portion and each configured to measure an intensity of light at a region of an outer surface of the second surface portion proximal to one of the light transmissive areas. By monitoring the light level at a portion of the front surface of the device directly adjacent to a light transmissive area, it is possible to ascertain an empirical measure of the contrast ratio between the transmissive area and said adjacent portion of the front surface (provided that the luminosity of the primary light source is known).

In examples of this embodiment, the device may further encompass a feedback system configured to adjust a luminosity or intensity of one or more of the primary light sources in dependence on the measured light level obtained by means of the one or more sensor elements.

According to one or more further embodiments, the second surface portion may be curved and/or the primary light sources arranged at non-uniform distances from the second surface portion.

Additionally, according to a second aspect of the invention, there is provided a lighting assembly, comprising a lighting device according to the first aspect of the invention, and a mirror arrangement, configured to intercept light transmitted through one or more of the light transmitting areas of the second surface portion and to reflect it in an alternate direction.

In this way, the lighting effect produced by the device may be fully or partially redirected, so that the effect is visible to observers not directly facing the front surface of the device for example.

### BRIEF DESCRIPTION OF THE DRAWINGS

Examples of the invention will now be described in detail with reference to the accompanying drawings, in which:

FIG. 1 schematically depicts a first example embodiment of the invention;

FIG. 2 schematically illustrates the optical effect created by embodiments of the invention;

FIG. 3 illustrates the visible optical effect created by embodiments of the invention;

FIG. 4 schematically depicts a second example embodiment of the invention;

FIG. 5 schematically illustrates the optical effect created by the second example embodiment;

FIG. 6 schematically depicts a third example embodiment of the invention;

FIG. 7 schematically illustrates the optical effect created by the third example embodiment;

FIG. 8 schematically depicts a fourth example embodiment of the invention;

FIG. 9 schematically illustrates the optical effect created by the fourth example embodiment;

FIG. 10 schematically depicts a fifth example embodiment of the invention;

FIG. 11 schematically illustrates the optical effect created by the fifth example embodiment;

FIG. 12 schematically depicts a sixth example embodiment of the invention;

FIG. 13 schematically illustrates the optical effect created by the sixth example embodiment;

FIG. 14 schematically depicts a seventh example embodiment of the invention;

FIG. 15 illustrates example patterns for the mirror arrangement comprised by the seventh example embodiment;

FIG. 16 schematically depicts an eighth example embodiment of the invention; and

FIG. 17 schematically depicts an example lighting assembly in accordance with an aspect of the invention.

### DETAILED DESCRIPTION OF THE EMBODIMENTS

The invention provides a lighting device configured to present to an observer a spatially dynamic sparkling light display. The device comprises a luminaire containing a plurality of primary light sources located on a first surface portion, such as a plurality of primary light sources mounted to a mounting surface portion, and arranged to direct light in a direction of a plurality of light transmissive areas formed within an opposing second surface portion. The opposing second surface portion may at least partially bound a lighting chamber within which the primary light sources are disposed, where an internal surface arrangement of the chamber is configured to absorb at least part of the spectral composition of any light emitted by the primary light sources which does not fall directly onto the light transmissive areas.

This arrangement is configured to ensure the maximal possible luminous contrast between the apparent luminosity of a light transmissive area which is in alignment with a primary light source and an observer's eye, and the apparent luminosity of regions of a front surface of the device immediately surrounding the light transmissive area. This ensures that only when an observer's eye is in alignment with a respective light transmissive area and primary light source is the primary light source visible at its full intensity and original spectral composition. As soon as this alignment breaks, the primary light source appears to the observer to vanish from view, or at least to significantly diminish or alter in intensity or spectral composition. It is this effect which provides the spatially dynamic glittering light effect.

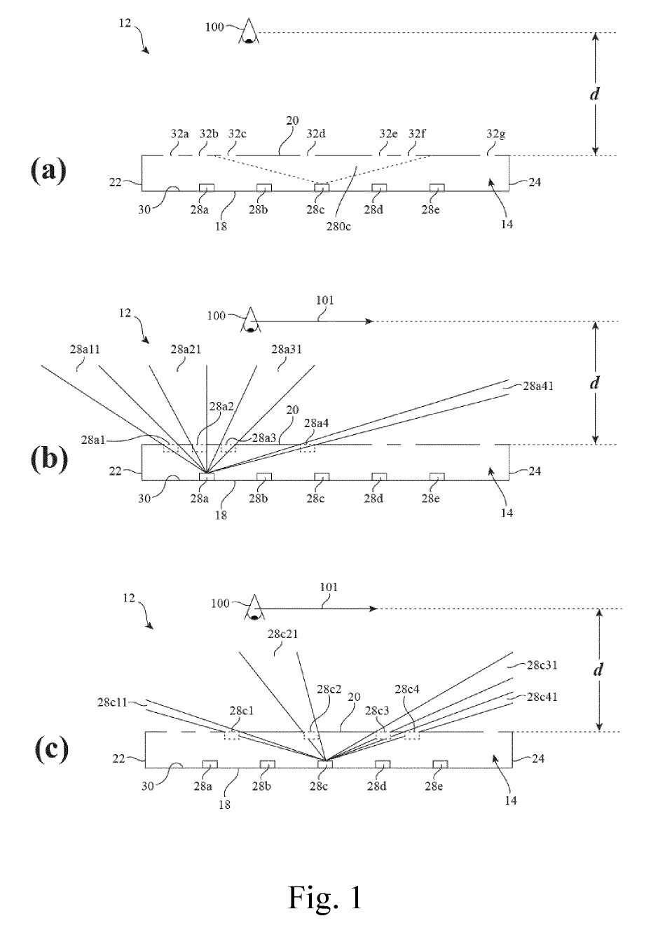

FIG. 1(a) schematically illustrates a first example of a lighting device 12 in accordance with an embodiment of the present invention, and which is demonstrative of the general concept of the invention embodied by all examples of the invention. The lighting device 12 comprises a panel or box shaped luminaire whose interior comprises a chamber 14 which is bounded by a back panel 18, front panel 20 and side panels (of which only two 22, 24 are shown in FIG. 1).

A plurality of primary light sources 28a-28e disposed within the chamber are located on a first surface portion of the chamber 14, being a mounting surface portion 30, which forms a portion of the upper surface of back panel 18. The primary light sources 28a-28e are operable to emit light having a particular spectral composition in a range of propagation angles in directions toward a plurality of light transmissive areas 32a-32g formed at various locations through front panel 20. For example, primary light source 28c is arranged to emit light in a range of propagation agles 280c towards the front panel 20, thereby illuminating light-transmissive areas 32c-32f. Each of the primary light sources 28a-28e may be a light source that comprises one or more light-emitting diodes (LEDs).

The panel or box embodiment of FIG. 1 comprises six internal surfaces, which include the respective interior surfaces of each of: the back panel 18, the front panel 20, first side panel 22, and second side panel 24 (plus two additional side panels, not shown). It is emphasised that this particular shape, having an internal surface arrangement comprising six surfaces is shown by way of example only, and other arrangements comprising for example a triangular or other polygonal shaped device may also be used.

The arrangement of internal surfaces is configured collectively to absorb at least a portion of any light emitted by the primary light sources 28a-28e which does not fall directly incident on the light transmissive areas 32a-32g, or is not emitted directly out through the light transmissive areas 32a-32g (in cases where these comprise simply holes or openings for example).

For instance, according to one example, each of the six internal surfaces of the device may be adapted or configured individually to fully absorb the whole of the spectral composition of light emitted by the primary light sources 28a-28e. In this case, any light not transmitted directly through windows or holes 32a-32g, and instead falling incident on one of the internal surfaces of the chamber 14 is fully absorbed by the particular internal surface at which it is incident. As a result, no secondary reflected light is generated by any one of the surfaces, and thus the only light available to exit the chamber is that which has been directly emitted by one of the primary light sources 28a-28e, out through one of the light transmissive areas 32a-32g.

When lighting device 12 is in operation, each primary light source 28a-28e illuminates at least a part of the plurality of light-transmissive areas 32a-32g to create a plurality of virtual secondary light sources. Each of these virtual secondary light sources is located on an exposed outer surface of the lighting device 12, being the outer surface of the front panel 20, and each virtual secondary ligt source corresponds to a light transmissive area 32a-32g that is illuminated by the primary light source.

FIG. 1(b) shows lighting device 12 in operation, wherein primary light source 28a illuminates light-transmissive areas 32a-32d thereby creating virtual secondary light sources 28a1-28a4 located on an exposed outer surface of front panel 20. Each of these secondary light sources 28a1-28a4 corresponds with a light-transmissive area and emits light in an angular range. For example, secondary light source 28a1 corresponds to light-transmissive area 32a and emits light in angular range 28a11. Furthermore, by being located on an exposed outer surface of front panel 20, each of these secondary light sources 28a1-28a4 is directly observable by the observer 100, located at a distance d from the front panel 20 of the lighting device 12, when the observer 100 is looking towards the front panel 20. It is noted that, although not shown in FIG. 1, lighting device 12 may have an additional layer located in between the front panel 20 and the observer 100. Such an additional layer should at least be transmissive for light emitted by the primary light sources 28a-28e at the locations of the light-transmissive areas 32a-32d. If such an additional layer would be present in the lighting device 12, the directly observable virtual secondary light sources are located at the exposed outer surface of this additional layer.

The angular ranges 28a11-28a41 are alternately spaced, which means that they are not overlapping and also not adjacent (or not proximate). Within each of the angular ranges 28a11-28a41, the observer 100 has a direct line of sight to primary light source 28a, while each of the angular ranges 28a11-28a41 is bounded by a region wherein no such direct line of sight exists.

FIG. 1(c) shows a similar situation, but now for primary light source 28c that illuminates light-transmissive areas 32c-32f thereby creating secondary (virtual) light sources 28c1-28c4, and alternately spaced angular ranges 28c11-28c41.

Of course, when lighting device 12 is in operation, both situations as illustrated in FIGS. 1(b) and 1(c) exist simultaneously. When the observer 100 is moving relative to lighting device 12 in a direction 101 while looking towards the front panel 20, he experiences the effect of light sources that significantly diminish or alter in intensity or spectral composition across a range of different positions relative to the lighting device 12. In other words, the observer 100 experiences a dynamic sparkling or glittering effect. The observer, looking at the front (outward-facing) surface of the front panel 20, sees light appearing to emanate from a particular light transmissive area 32a-32g only when there is complete alignment between the observer's eye, the light transmissive area in question and one of the primary light sources 28a-28e disposed within the chamber 14. When this situation does not exist, no light is able to enter the observer's eye via the particular transmissive area, since all secondary reflected light which might have escaped through the transmissive area has been eliminated.

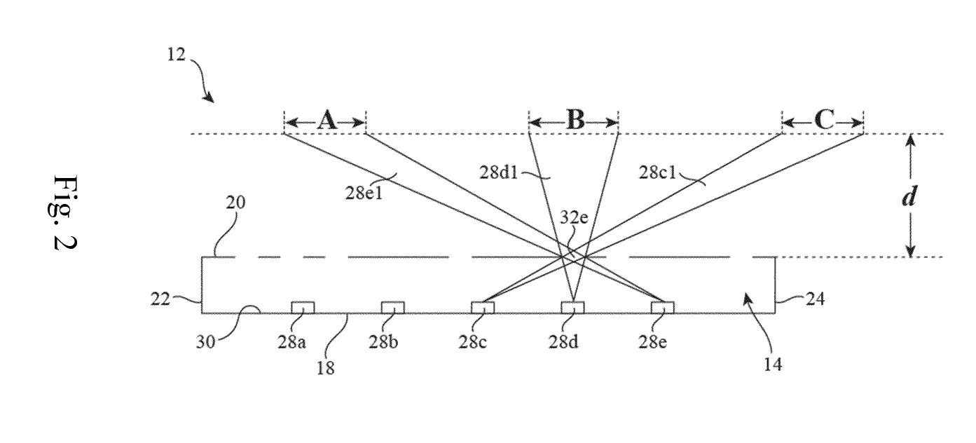

The aforementioned effect is also illustrated in FIG. 2, which shows a schematic representation of the effect in relation to light transmissive area 32e for an observer located at a distance d from the front panel 20 of the device. FIG. 2 illustrates for each of the primary light sources 28c-28e proximal to the light-transmissive area 32e in question the maximal range of angles over which light emitted by the respective primary light sources 28c-28e is able to propagate through the light-transmissive area 32e and reach a point along the plane at distance d. The two lines extending from each of the respective primary light sources 28c-28e represent the boundaries of the respective angular ranges 28c1-28e1, respectively.

The particular angular constraints of the three primary light sources 28c-28e provide three discrete linear (as represented in this 2D schematic diagram) regions A, B, C along the distance d line within which light emitted by one of the 1 primary ight sources 28c-28e is able to enter the eye of an observer located at that position through light transmissive area 32e. Outside of regions A, B and C, no light is able to reach distance d through light transmissive area 32e from any of the three proximal primary light sources 28c-28e. Hence, according to the particular example mentioned above in which the internal surfaces of the chamber 14 are configured to fully absorb the full spectral composition of light emitted by the primary light sources 28a-28e, outside of regions A, B and C, no light exiting the chamber 14 is able to reach an observer's eye at distance d via transmissive area 32e, and so to an observer in those regions, the transmissive area 32e does not appear illuminated.

Furthermore, where the front (observer-visible) surface of the front panel 20 is also configured to be completely non-reflective, then outside of regions A, B, and C, transmissive area 32e is effectively hidden from view, since both the area 32e itself and the surrounding portions of the front surface 20 appear black (in an ideal scenario) to an on-looking observer.

The same effect illustrated for light transmissive area 32e in FIG. 2 is replicated for each of the light transmissive areas 32a-32g across the front panel 20, so that an observer moving relative to the front panel 20 along a line or plane at distance d is almost continually moving into and out of respective visible zones corresponding to each of the transmissive areas 32a-32g across the front panel 20. The optical effect is the observance of different secondary (virtual) light sources, emanating from the various light transmissive areas 32a-32g, constantly appearing and vanishing sharply in response to movement. This effect is referred to in this application, and in the art, as spatially dynamic sparkling or glittering; sparkling which is effected by movement.

It is noted that it can be seen from FIG. 2 that the intended sparkling effect is in fact only created for observers positioned at a certain minimum distance from the front panel 20 (i.e., at a distance larger than a threshold distance). At distances from the front panel smaller than the threshold distance, the three visible zones converge together, such that for each light transmissive area, the area is visible across a broad, substantially continuous range of angles. In addition, because the areas converge, light from more than one primary light source may enter an observer's eye at a given time, potentially breaking the illusion of a single bright point source appearing to emanate from the light transmissive areas.

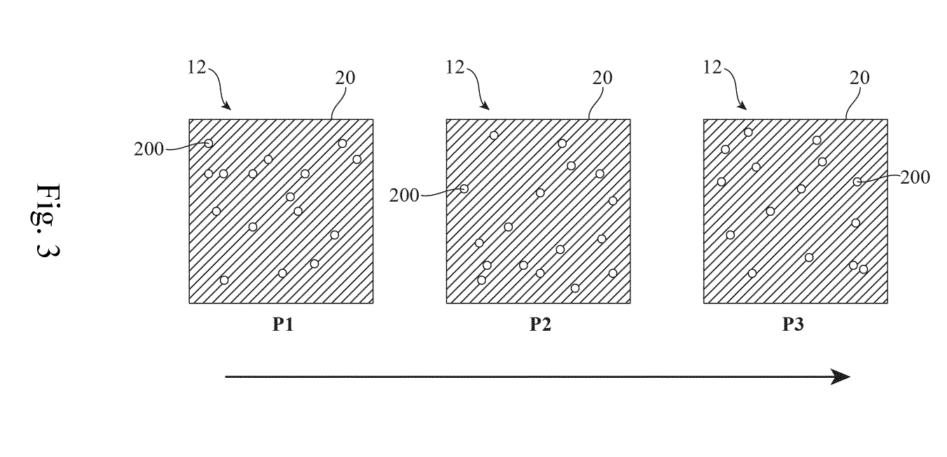

The sparkling effect created is illustrated schematically in FIG. 3 which depicts an example series of views of the lighting device 12 as seen from different positions P1, P2 and P3 along a fixed, or substantially fixed, distance from the front panel 20. As an observer moves from first position P1, to second position P2, certain of the visible light spots 200 disappear, and others appear in their place. As the observer moves, again, some of the bright spots 200 appear to vanish from view, and different spots come instead into view. As the observer moves further along, spots which previously disappeared may reappear again, as they enter into a different visible zone for the respective light transmissive area.

The rate of change between the different ‘frames’ illustrated by way of demonstration in FIG. 3, with respect to lateral motion, may be engineered have one of a range of different values, by configuring the relative positions of the light transmissive areas and primary light sources appropriately. Changes may for example be desired to be extremely rapid, such that transitions between ‘frames’ appears almost continuous or seamless. Alternately, a more disjointed, discrete twinkling or sparkling may be desired, in which the case, the rate of change might be engineered accordingly. The intended end use of the product may have to be considered, since this may affect the average rate at which a typical observer of the device may in practice be expected to move past it.

Although in the above descriptions, the particular example has been considered of inner surfaces which are each independently adapted to fully absorb the full spectral composition of light emitted by the primary light sources falling incident on them, other variant configurations are possible which would still achieve the desired sparkling effect.

In one set of examples, for instance, each inner surface may independently be adapted to absorb light of the whole spectral composition, but to only partially absorb the light, such that there is some secondary reflection, and some secondary light is allowed therefore to escape the chamber. Such a configuration may, within certain parameters, still provide a device which produces the desired spatially dynamic glittering effect, but may produce an effect for instance which is aesthetically less striking or attractive. However, such a configuration may in practice prove significantly simpler and less costly to produce, since absolute absorption by the walls need not be obtained. For this reason such an embodiment may constitute a desirable variation.

In particular embodiments for example, and without wishing to be bound by theory, the internal surface arrangement may be configured to absorb sufficient light such that a contrast ratio between light emitted directly through the light transmissive areas by the primary light sources and light emitted indirectly by secondary reflection is between 10 and 100. Sufficiently high contrast may be achieved through an altered spectral composition of the secondary reflected light, through diminished intensity of the light as a result of partial absorption, or through a combination of both. In any case, the glittering effect relies upon a sufficiently clear or sharp apparent contrast between light emanating directly from a primary light source and light exiting the chamber as a result of reflection from internal surfaces. However, it is emphasised that this effect may or may not manifest in a particular measurable or observable contrast ratio, and the above is described by way of example only.

In other examples, the overall arrangement of inner surfaces may collectively be configured to fully or partially absorb the full spectral composition of the light emitted by the primary light sources, but wherein some individual internal surfaces are not themselves absorptive in this way. For instance, considering the embodiment of FIGS. 1 and 2, where the primary light sources 28a-28e are adapted to emit light in direction across a range of angles which does not exceed 180° (i.e. where they emit light only in a relative forwards direction) then the mounting surface portion 30, upon which the primary light sources 28a-28e are mounted, may be configured even to be fully reflective of all frequencies of light, without (in an ideal scenario) influencing the apparent optical effect of the device at all. This is the case provided that the remaining five inner surfaces of the chamber 14 are each independently adapted to fully absorb the full spectral composition of light incident at them. If this were not so, light from the primary light sources 28a-28e might be reflected from one or more of the other internal surfaces onto the mounting surface portion 30 and out through one or more of the light transmissive areas 32a-32g, influencing the optical effect generated for an observer.

According to further examples, the arrangement of internal surfaces may be configured or adapted to absorb (fully or partially) only a portion of the spectral composition of light emitted by the primary light sources 28a-28e. This in practice may manifest itself as a change in the colour of the light upon reflection from the wall; certain frequency components are absorbed while others are reflected. For example, the primary light sources 28a-28e may be adapted to generate and emit white light, and the inner surfaces of the chamber 14 adapted to reflect frequency components which correspond to the colour green.

Alternatively, light generated by primary light sources may generally have a spectral profile which comprises for example a major frequency component corresponding to a particular colour of light and one or more secondary frequency components corresponding to one or more different colours. The light might for example have a major component corresponding to the colour blue and a minor component corresponding to the colour red. In this case, inner surfaces of the chamber 14 might for instance be adapted to reflect frequency components corresponding to only the minor component, such that only red light is reflected, while light directly emitted from the primary light sources appears predominantly blue by virtue of the blue major component.

According to this example, two sources of light are allowed to exit the chamber; a diffuse background light of a particular colour (or reduced spectral composition), which exits at a wide range of angles through every opening or window in the front panel, as well as more directional light of a broader spectral composition and greater intensity or brightness, which is emitted directly through the light transmissive areas of the front panel by each of the respective primary light sources, and brings about the sparkle effect.

According to particular (non-limiting) examples of any embodiment described in this application, the light transmissive areas 32a-32g may comprise openings or holes in the front panel 20, or may in alternative examples comprise window elements made from one or more light transmissive materials. The light transmissive areas 32a-32g may in examples be fully light transmissive or partially light transmissive. In certain examples, one or more of the light transmissive areas 32a-32g may be adapted to transmit only a portion of the spectral composition of light generated by the plurality of primary light sources 28a-28e, i.e. the transmissive areas are adapted to transmit light only of a particular set or range of frequencies or wavelengths. This may be achieved for example by means of one or more colour filters comprised by or constituting either the whole or a portion of one or more of the light transmissive areas.

Furthermore, reference to the term ‘front panel’ is to be understood to mean reference to a wall, panel, or other boundary of the device which faces in a direction toward potential observers and through which the light generated by primary light sources is seen by observers; an outward or observer facing façade or cover.

Additionally, in accordance with any embodiment of the invention, the primary light sources may in examples be, or may comprise, solid state light sources, such as LEDs. Use of LEDs provides for high energy efficiency and also relatively sharp directionality of emitted light. In alternative examples, conventional light sources, such as filament light sources may instead be used. However, these provide reduced efficiency both in terms of energy and the distribution of emitted light; filament bulbs (without additional optics) produce a Lambertian distribution, which leads to much wasted light, through emission in directions which are not required (such as behind the light source).

According to any embodiment of the invention, the primary light sources may be provided mounted via a Metal Core Printed Circuit Board (MCPCB). Primary light sources may be provided in a regular N×M array (in which M, N are positive integers), an irregular array, or may be positioned in an arbitrary arrangement.

In one or more examples of the invention, the arrangement of the plurality of primary light sources 28a-28e on the mounting portion 30 may be such that each primary light source is horizontally or laterally displaced from any light transmissive area 32a-32g of the front panel 20. The effect of this is that an observer looking through a light transmissive area, in a direction of the optical axes of the primary light sources, is not able to observe the full arrangement of the primary light sources lying beneath. This adds to the interest and enjoyment of the resultant display, since the mechanical workings providing the sparkling effect are not immediately apparent.

According to these or other examples, the primary light sources might be arranged according to a first regular pattern, and the light transmissive areas arranged according to a second different regular pattern. The patterns may differ in the pitch between neighbouring primary light sources and/or light transmissive areas, or may differ simply in their relative alignment, so that the elements of the first are arranged to interleave with the elements of the second.

Alternatively, the light transmissive areas and/or the primary light sources may be arranged according to an irregular pattern, such as a random or semi-random pattern. The advantage of using such a pattern for one of either the light transmissive areas or the primary light sources is that this affords a degree of freedom in the arrangement of the other, since substantial non-alignment of primary light sources and transmissive areas may be expected to follow automatically from the irregularity of the pattern used. For instance, by arranging the window elements semi-randomly, then this allows the primary light sources to be arranged according to a standard regular array configuration, which may be substantially cheaper and easier to manufacture.

By random or semi-random is meant a pattern or arrangement for example in which the separation distance, pitch or relative angular arrangement of subsequent or adjacent elements in the pattern (primary light sources or light transmissive areas) differs or varies in a non-regular way.

In particular examples, the primary light sources and/or light transmissive areas may be arranged to follow a Voronoi-like pattern or arrangement.

In accordance with embodiments of the invention, particular dimensional constraints or ratios may be preferred for aesthetic, structural or functional reasons. In particular, the following descriptions are intended to be most applicable for embodiments of the lighting device comprising a panel or box-shaped construction, as in the above described embodiments, and also in the majority of the embodiments to be described below.

For interior design purposes, the overall width of the panel may be in the order a single metre, and the light emitting components may be individual LEDs, having typical dimensions of approximately 1 mm.

For interior design applications, the ‘vertical’ separation distance between the front 20 and back 18 panels may, for a “thin” panel, not exceed approximately 50 mm, and in addition, for practicality reasons, may typically not be less that 1 mm. For an aesthetically appealing effect, in which primary light sources 28a-28e do not appear overly ‘crowded’, the primary light source size may be smaller than the separation distance between any two neighbouring primary light sources. However, to ensure that the display does not appear too sparse, and to achieve a noticeable effect, the separation distance between any two neighbouring primary light sources may be kept to within 20 times the size or width or diameter of each primary light source.

Also to maximise the aesthetic appeal, so that the display does not appear too sparse, but at the same time to achieve a noticeable effect, the light transmissive areas 32a-32g may be formed having a separation distance which does not exceed 20 times the width or diameter of said light transmissive areas.

In order that an observer is not able to see two of the primary light sources 28a-28e through a single one of the light transmissive areas 32a-32g, the width or diameter of each light transmissive area may be smaller than the separation distance between neighbouring primary light sources. However, in order to ensure a visible and optically efficient (i.e. little wasted light) glittering effect, each light transmissive area may be formed with a size not substantially smaller than the width or diameter of the primary light sources.

Variations within the above parameters may influence the resultant sparkling effect. For example, the shorter the separation distance between the front panel 20 and the back 18, the slower the ‘on/off’ transitions between visibility of a given primary light source 28a-28e and apparent vanishing of said primary light source. In addition, larger light transmissive areas 32a-32g render the sparkling more obvious and plainly visible, while smaller transmissive areas render it more subtle and elegant.

For outdoor architectures, the device may be constructed with larger overall outer dimension (for example several metres), and the primary light sources 28a-28e may comprise clusters or assemblies of LEDs instead of individual LEDs. The geometry described above in connection with indoor architectures is scalable and adjustable for the size of the overall panel, the distance of the viewer to the panel and the speed of the viewer (walking-by viewer or cycling-by viewer). Critical parameters and LED size are also scalable in the same way, so that LEDs for example may, according to the particular application, have (by way of example only) dimensions of 1×1 mm, 4×4 mm or 10×10 mm (e.g. chip-on-board (COB) LEDs).

Diameters of light transmissive areas may also vary for different applications, as well as the front-back panel separation distance. According to particular examples, front-back panel separation distance may (by way of non-limiting example only) have values for instance of 10 mm, 50 mm or 200 mm. However, as will be appreciated by the skilled person, the example dimensions given with respect to front-back panel separation distance, as well as for LED size, are given by way of example only, and other particular dimensions may equally be used in any embodiment of the invention.

In at least some embodiments, the device may be adapted to produce sparkle effects of different colours under different viewing angles. For example, the device may comprise a plurality of LEDs each having a light exit surface covered by a suitable phosphor to alter the spectral composition of the light produced by the LED as it travels through the phosphor layer. As is well-known per se, such arrangements typically produce colour over angle (COA) effects due to the angular dependence of the length of the path of the emitted light through the phosphor layer, which may lead to the generation of a sparkle effect of different colours at different viewing angles of the emitted light.

Alternatively, and according to one group of embodiments, the device comprises at least two sets of primary light sources, each set adapted to emit light of a different spectral composition. In practice, this may manifest itself as the emission of differently coloured light by each set. In these embodiments, the device further comprises a plurality of optical elements which are together configured to direct light emitted by each of the different sets of primary light sources through light transmissive areas of the opposing second surface portion at different ranges of propagation angles. The effect of this is that an observer may perceive sparkling lights of differing colours depending upon the angle at which he or she is standing relative to the front surface of the device. Colours may change as the observer moves, so that some particular colours are seen only in certain angular regions.

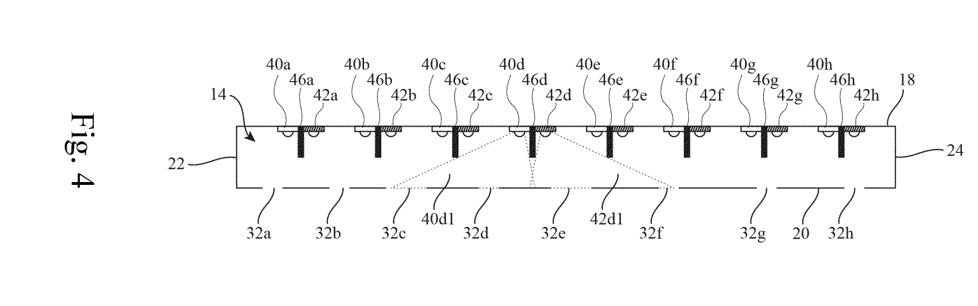

A first example of such an embodiment is schematically illustrated in FIG. 4. The device comprises a panel or box shape frame, having a back panel 18, front panel 20, and side panels 22, 24 (plus two other side panels not shown) which bound an internal chamber 14 within which are disposed two sets of primary light sources. A first set consists of primary light sources 40a-40h, and a second set of primary light sources 42a-42h. The front panel comprises light transmissive areas 32a-32h.

The first set of primary light sources 40a-40h is adapted to emit light of a green colour. The second set of primary light sources 42a-42h is adapted to emit light of a red colour. The primary light sources are disposed along the inner surface of the back panel 18 in pairs arranged at regular intervals, one of each pair belonging to each of the first set of primary light sources 40a-40h and the second set of primary light sources 42a-42h. Disposed between the two primary light sources of each pair is a respective light-blocking element 46a-46h.

As illustrated in FIG. 4(a), the effect of the light blocking elements 46a-46h is to constrain or limit the range of angles over which light emanating from each of the first set of primary light sources 40a-40h and the second set of primary light sources 42a-42h is able to propagate. For example, the light emanating from primary light sources 40d and 42d is only able to propagate over the range of angles 40d1 and 42d1, respectively. Light blocking element 46d prevents red light from primary light source 42d being emitted past a particular maximal angle toward the left (as seen in the Figure) of the device, and it prevents green light from primary light source 40d being emitted past a particular maximal angle toward the right (as seen in the Figure) of the device.

The light blocking elements 46a-46h also define a range of acute angles very close to the device (both on the left and right) within which no light is visible from either of the first set of primary light sources 40a-40h and the second set of primary light sources 42a-42h.

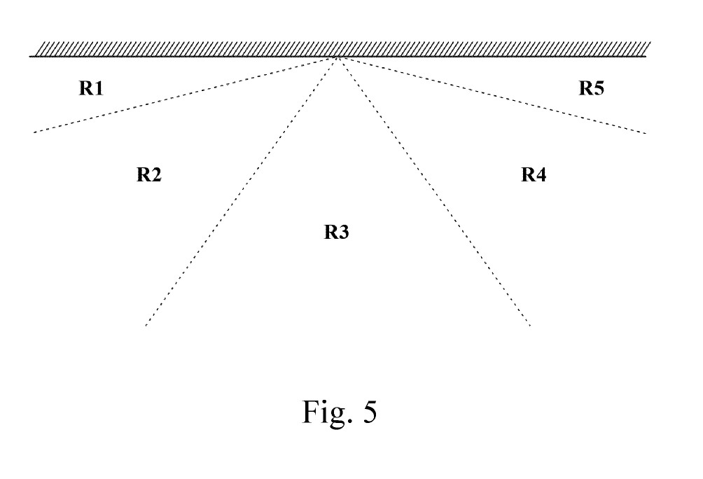

The angular constraints imposed by the light blocking elements 46a-46h are illustrated in FIG. 5. FIG. 5 illustrates the colour of sparkling light that an observer would see if facing (and moving—for sparkling) in a direction relative to the panel lying within the particular angular range indicated. For angular ranges R1 and R5, no light is visible. For angular range R2 only green sparkling light is seen, for angular range R4 only red sparkling light is seen, and for the central angular range R3, both green and red sparkling lights are seen.

Of course, as will be appreciated by the skilled person, red and green are merely examples of colours that could be used in accordance with this embodiment, and any other combination of colours may alternatively be used.

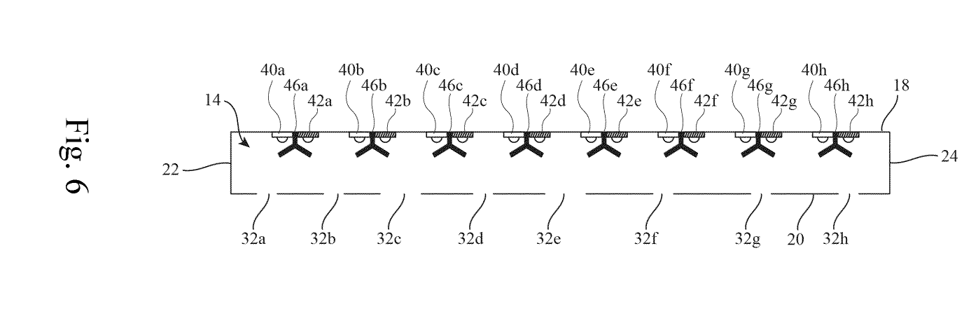

FIG. 6 shows a second example of this group of embodiments. The device comprises the same components as the example of FIG. 5, but differs in the shape of the light blocking elements 46a-46h which here comprise angularly extending fork shapes, as opposed to simple vertical wall elements. The effect of the fork elements is to effectively provide complete isolation of the two colours of light, eliminating the central region of mixed green and red light which existed in the previous example.

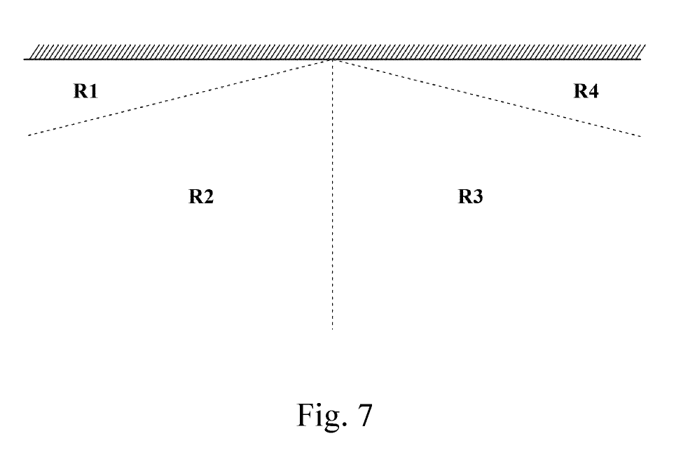

Instead, as shown in FIG. 7, two angular regions R2 and R3 are created, one to the left (as seen from the schematic view provided by FIG. 6), and one to the right, region R2 corresponding to angular directions in which green sparkling light will be observed and region R3 corresponding to angular directions in which red sparkling light will be observed. In angular ranges R1 and R4, no light is visible. The effect of this is that when walking in any direction from left to right along the panel, only green (sparkling) light is seen, and when walking from right to left only red light is seen.

Additionally, when walking from left to right for example and looking forwards in a direction toward the panel, only green (sparkling) light is seen, but when walking in the same direction but looking backwards in a direction toward the panel, only red light is seen. The same effect in reverse would be observable when walking from right to left. Also, depending upon the particular configuration and specifications of the primary light sources, when walking in either direction but looking straight on toward the panel, i.e. along a line of sight exactly or substantially parallel with the optical axes of the plurality of primary light sources, a viewer may observe either no light emitted from the panel, may observe sparkling light of both red and green light, or may observe both red and green light, but wherein the sparkling effect is not present.

Again, red and green are merely exemplary colours which may be employed in accordance with this embodiment.

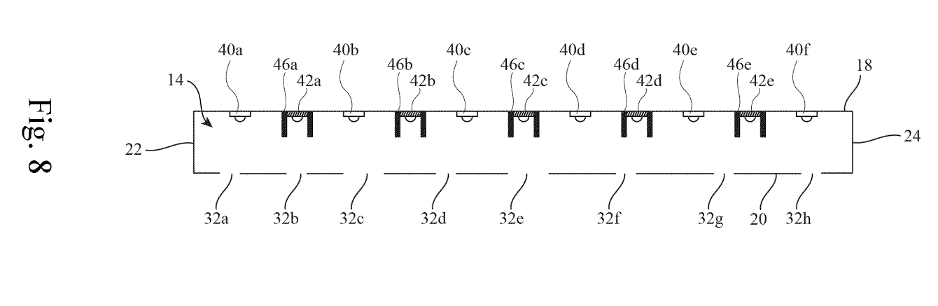

FIG. 8 shows a third example of this group of embodiments. This differs from the examples of FIGS. 4 and 6 in that the primary light sources are not arranged in directly adjacent pairs of differently emitting sources. Rather the primary light sources are arranged singly, with the first set of primary light sources 40a-40f interleaved with the second set of primary light sources 42a-42e, so that elements from the first and second sets are arranged alternately along the length of the back panel 18. As with the previous examples, the first set of primary light sources 40a-40f is adapted to emit light of a spectral composition corresponding to the colour green, and the second set of primary light sources 42a-42e to emit light of a spectral composition corresponding to the colour red. Each of the second set of primary light sources 42a-42f is bounded on either side by a pair of light blocking elements 46a-46e, comprising linear vertical wall elements.

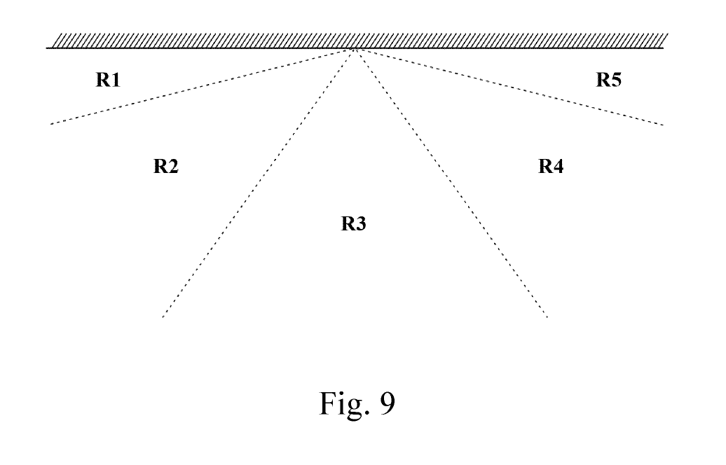

As shown in FIG. 9, the effect of the light-blocking elements 46a-46e is to constrain the angular range of just the second set of primary light sources 42a-42e (the red lights), so that green sparkling light is visible in regions R2, R3 and R4, for observers facing and moving in all directions relative to the device (except in the relatively narrow regions R1 and R5 shown in FIG. 9 in which no light is visible), but red light is visible only within a central angular range corresponding to region R3. Here, both red and green lights are observed.

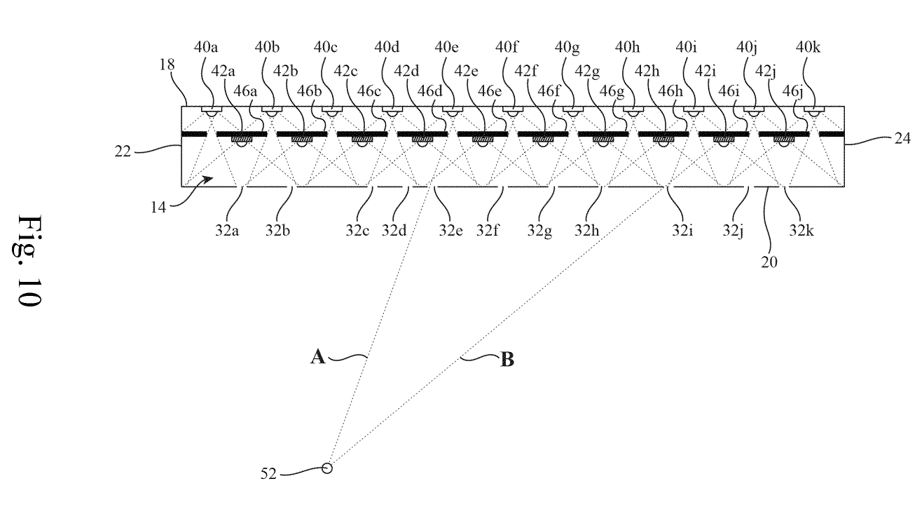

FIG. 10 shows a fourth example of this group of embodiments, again comprising two different sets of primary light sources, each set configured to emit light corresponding to a different colour of visible light. In this case a first set of primary light sources 40a-40k are disposed at regular intervals along the internal surface of back panel 18, and are configured to emit light which is red. A second set of primary light sources 42a-42j are disposed at horizontally interleaved positions, along a line (or plane) vertically displaced from the back panel, between the back panel 18 and the front panel 20. Each primary light source 42a-42j is mounted to a surface of a respective light blocking element 46a-46j, formed of a horizontally linear wall element. The light blocking elements 46a-46j are horizontally aligned, with each pair of neighbouring blocking elements defining a narrow space between them aligned vertically with each of the first set of lighting elements 40a-40k. These gaps define the angular constraints of the light emitted by the first set of primary light sources 40a-40k.

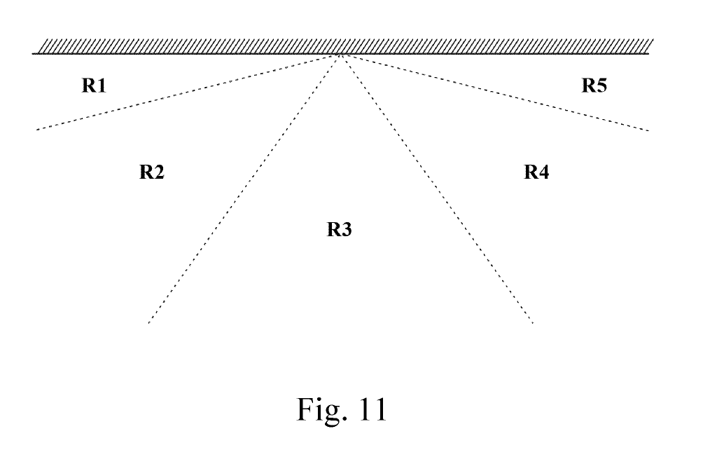

As shown in FIG. 11, the effect of this arrangement is to allow yellow sparkling light (emitted by the second set of primary light sources 42a-42j) to be seen by observers facing and moving at any angle and direction relative to the front panel 20 (except the relatively narrow ranges R1 and R5 shown in FIG. 11 in which no light is visible), but to constrain the visibility of red sparkling light (as emitted by the first set of primary light sources 40a-40k) to just a central angular range R3. In this central range R3, both yellow and red lights are observed. An example observer eye position 52 is shown in FIG. 10, and exemplary angular travel directions A and B illustrated by lines indicating the line of sight along such directions. Direction A lies within the central angular region R3, and here both red and yellow lights are observable. Direction B lies within angular region R2, and when facing and moving in this direction, as illustrated, only light emitted by the yellow primary light sources 40a-40k and not light emitted by the red primary light sources 40a-40k is able to reach the observer's eye 52.

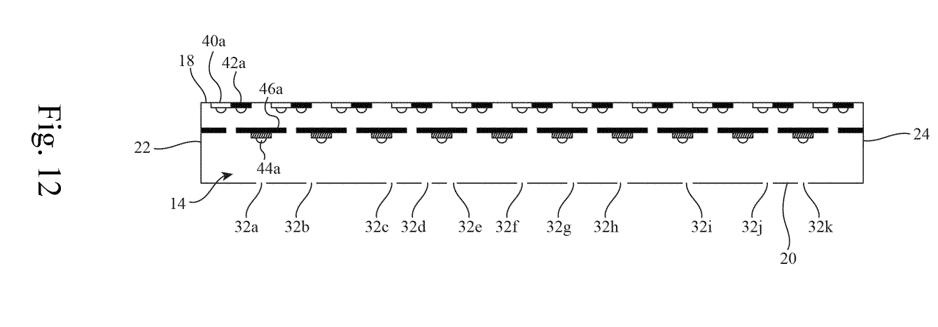

FIG. 12 shows a more complex example of this embodiment, comprising in this case three distinct sets of primary light sources, each adapted to emit light of a spectral composition corresponding to a different colour, a first set of primary light sources containing primary light source 40a is adapted to emit blue light, a second set of primary light sources containing primary light source 42a is adapted to emit red light, and a third set of primary light sources containing primary light source 44a is adapted to emit yellow light. As with the examples of FIG. 10, the primary light sources are divided between two vertically displaced planes, with the third set of primary light sources containing primary light source 44a mounted to surfaces of light blocking elements (such as light blocking element 46a) which are arranged in horizontal alignment, and together defining a plurality of regularly spaced openings formed by the gaps between neighbouring elements. The first and second sets of lighting elements are arranged in pair formation, as in the examples of FIGS. 4 and 6, with each pair formed of a blue-emitting primary light source (such as primary light source 40a) on the left and a red emitting primary light source (such as primary light source 42a) on the right. The gaps formed between neighbouring light-blocking elements are aligned horizontally with the centre of each pair formation.

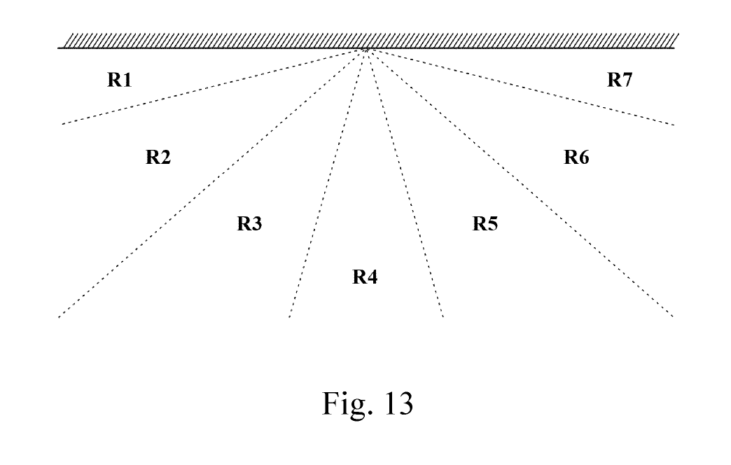

The effect of this arrangement is shown in FIG. 13, which illustrates the colours of light visible when facing and travelling in different angular directions relative to the front panel. No light is visible is ranges R1 and R7. Yellow light is visible over all angles in ranges R2-R6. Red light is visible only when facing and moving at least partially right-ward (ranges R3 and R4. Blue light is observable over a relatively narrow range R5 of right-ward angles only.

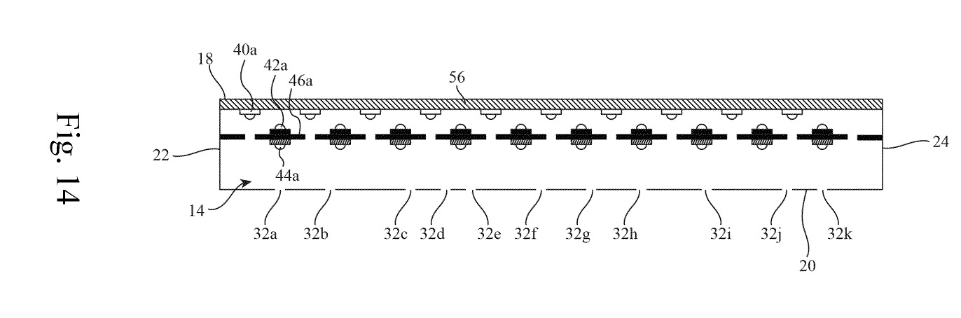

FIG. 14 shows a sixth example of an embodiment comprising primary light sources of multiple colours. As in the previous example, this example comprises three distinct sets of primary light sources. The first set of primary light sources containing primary light source 40a is adapted to emit green light, the second set of primary light sources containing primary light source 42a is adapted to emit yellow light and the third set of primary light sources containing primary light source 44a is adapted to emit blue light (these of course, as in the previous examples, merely being exemplary).

In this case however, the second set of primary light sources containing primary light source 42a is mounted to the rear of the horizontally aligned light blocking elements (such as light blocking element 46a), and light from these sources reaches the front of the panel by means of specular mirror arrangement 56 mounted across the inner surface of back panel 18. The specular mirror arrangement comprises a patterned surface which reflects light emitted by the second set of primary light sources containing primary light source 42a in correspondence with this pattern and redirects it toward the front panel 20 and the light transmissive areas 32a-32k formed across it. Light emitted from the first set of primary light sources containing primary light source 40a is angularly constrained by the light blocking elements, and light emitted by the second set of primary light sources containing primary light source 42a is also similarly angularly constrained, as well as patterned by means of the pattern formed on the specular mirror arrangement 56.

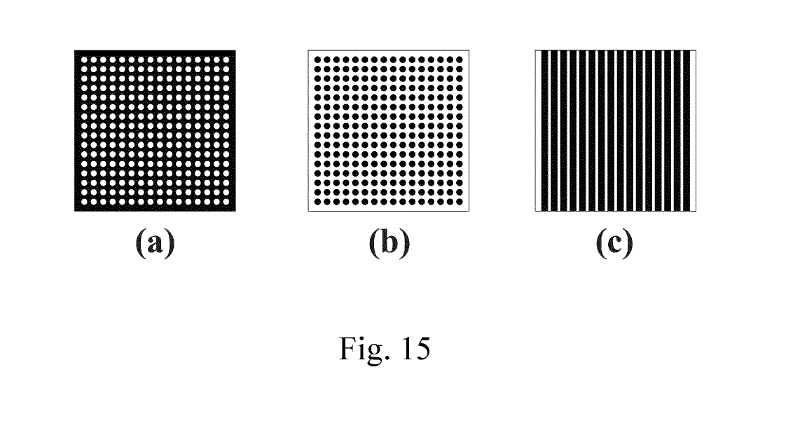

Three examples of possible patterns for the specular mirror arrangement 56 are illustrated in FIG. 15. The patterns in these examples are formed by means of printing black paint onto the surface of a glass mirror. Other fabrication techniques however might alternatively be employed.

The arrangement of FIG. 14 produces a display configuration of many different colour-angle combinations, and the particular angular distributions may depend upon the pattern of the mirror arrangement 56, the width of the gaps between neighbouring light blocking elements and the vertical separation between the second set of primary light sources containing primary light source 42a and the mirror arrangement 56.

According to any of this group of embodiments, the light blocking elements may be fabricated by means of 3D printing onto a PCB (for example MCPCB) to which the primary light sources are mounted. The light blocking elements may in examples be completely absorbing, or may alternatively be partly or fully reflective (for example specularly reflective). The light blocking elements could themselves be different colours in different examples, for example black where absorption is desired, or white where more reflection is desired.

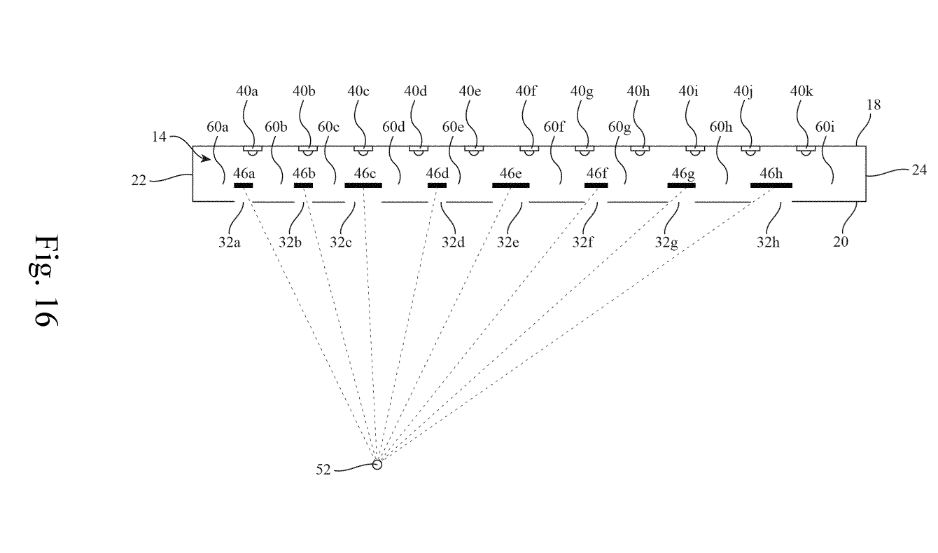

In FIG. 16 is shown a different embodiment of the invention, comprising a single set of primary light sources 40a-40k disposed along an inner surface of back panel 18. The device further comprises a set of horizontal linear light blocking elements 46a-46h, arranged in horizontal alignment with the light transmissive areas 32a-32h. As illustrated, these have the effect of forming at observer eye position 52 a single discrete ‘blind spot’ at which view of all primary light sources 40a-40k becomes obscured, regardless of the angular direction of travel of the observer. By adding additional layers of light blocking elements, multiple such blind spots may be created.

According to examples of any embodiment of the invention, additional optical elements may be provided to shape or redirect light emitted by one or more of the primary light sources. For example, these elements may include a lens such as a converging lens or a Fresnel lens (to achieve a degree of collimation of the emitted light), or may include a prism adapted for instance to split or redirect emitted beams of light.

These elements may additionally or alternatively comprise one or more colour filters or films, for enabling transmission of light of only a particular set or range of frequencies or wavelengths. These filters or films may in examples be provided comprised by, or positioned in optical alignment or correspondence with, one or more of the light transmissive areas. Alternatively, said filters or films may be positioned in alternative locations within the chamber, for example disposed atop light emitting surfaces of one or more of the primary light sources, or arranged in optical alignment with optical axes of one or more of the primary light sources.

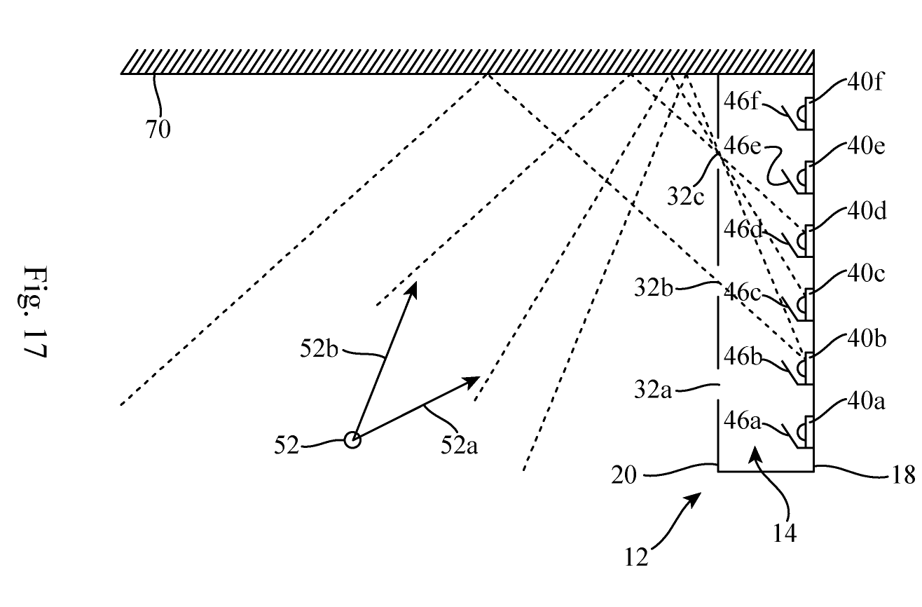

According to one example, illustrated in FIG. 17, there is provided an assembly comprising a lighting panel or box 12 in accordance with embodiments of the invention, and a mirror 70 arranged at an angle (in this case perpendicularly or substantially perpendicularly) with respect the front panel of the lighting device. The device 12 comprises light blocking elements 46a-46f configured so as to deflect light emitted by the primary light sources 40a-40f in a tangential direction through the light transmissive areas 32a-32c and toward the surface of the mirror 70 from which it is reflected. In consequence of the shape of the light blocking elements 46a-46f, an observer situated in a position 52 does not see any light emanating from the device when looking in a direction 52a directly at the front panel 20, but does see the sparkling effect when looking in a direction 52b towards the mirror 70. The assembly of FIG. 17 effectively provides a means of reorienting the sparkling effect to render it visible when not looking directly at the panel. This can produce a visually striking effect, since the source of the light display is not immediately apparent; the device itself does not appear to be generating any light (to an observer looking from position 52).

In any embodiment of the invention primary light sources may be provided adapted to emit a plurality of colours, either simultaneously, or singly, where in the latter case the primary light sources have a changeable output colour for example.

The primary light sources may for example be adapted to individually emit light having a first spectral composition across a first range of propagation angles, and to emit light having a second spectral composition across a second range of propagation angles. Alternatively, the primary light source may be adapted simply to emit light of the first composition across a first portion a light emitting surface and light of the second composition across a second portion of a light emitting surface. The different spectral compositions may manifest as light of differing colours. In either of the above cases, said one or more of the primary light sources may be adapted to emit light exhibiting a colour gradient.

Use of such primary light sources may allow for a simple means of providing a multi-colour sparkling effect, for example a single apparent point source which changes colour depending upon the angle at which it is viewed or approached.

In one or more examples, the device may comprise primary light sources adapted to emit one or more of each of the colours red, green and blue. Primary light sources may be provided operable to emit any one or any combination of these colours.

In some examples, one or more of the light transmissive areas may comprise colour filters adapted to filter outgoing light so as to comprise frequency components corresponding only to a particular colour.

According to any embodiment of the invention, the front panel 20 of the device may be made of cardboard or other sheet material. Cardboard may have a thickness for example of approximately 4 mm.

The light transmissive areas may in examples be tapered. This may provide advantageous effect in the case that the front panel element has a relatively large thickness and the light transmissive areas have a relatively small diameter. In this case, exit of light is blocked at narrow angles to the front of the panel. By providing light transmissive areas which are tapered (depth-wise) in their diameter (i.e. larger diameter at the back side of the front panel compared with at the front side, or vice versa), sparkling light is visible to an observer across a much broader range of angles, since light is not blocked at the narrow angles as before.

The light transmissive areas may in examples be provided by holes formed at an angle (or different angles) through the cardboard. By providing such holes aligned at angles non-parallel with optical axes of the primary light sources, the range of angles over which the sparkling light effect created by the device is visible to observers is accordingly restricted. This may be used in examples to direct the light effect to be visible only (or predominantly) at relatively narrow angles to the panel for instance, such that the panel is visible to observers far away from the panel, walking or positioned in relatively acute angles to the front of the panel. This may attract potential customers to the lighting panel from far distances away for instance.

The front panel may in examples comprise a glass plate, having a layer of black (or other absorbing) paint applied to one side. The light transmissive areas may in this case be provided by non-painted areas of the glass plate, or areas where paint has been removed. A paint layer may be applied either to one side or to both sides of the glass plate.

In some examples, the front plate may comprise a glass mirror, having non-silver regions to form the light transmissive areas. Such an embodiment must be in accordance with however the general requirement that the overall arrangement of internal surfaces be such as to absorb at least part of the spectral composition of light emitted by the primary light sources not falling directly incident on the light transmissive areas.

The light transmissive areas may in some examples be formed simply by regions of the front panel where the material is thinner than in the remainder of the panel.

The above described variations may equally be applied to the construction of the side walls 22.

In the above described embodiments, examples have been described in detail comprising box or panel-shaped devices. These comprise a frame structure consisting of a back panel 18, a front panel 20 and four side panels 22, 24. Such a construction is simple and cheap to manufacture. It also allows the device to be very lightweight. The architecture allows for easy assembly. Furthermore, in examples, holes may be cut into a front panel quickly and easily by automated digital manufacturing techniques such as laser cutting or stamping, allowing speed, low-cost and customisability.

However, it is to be understood that the inventive concept is not limited to such box or panel shaped constructions. In alternative examples, the device may comprise a frame bounding an internal chamber having any desired outer shape, for example cylindrical, spherical, ellipsoidal, pyramidal, cone-shaped, or any non-regular variation on one or more of these or other shapes.

In one example, for instance, a tubular construction may be provided, wherein the primary light sources are disposed on a dedicated mounting surface portion provided in the middle of the chamber, such that the primary light sources are arranged to direct light outward in directions toward the cylindrical walls of the chamber, the inner surfaces of which form the opposing second surface portion through which the light transmissive areas are formed.

In particular examples, there may be provided lighting strips running through the chamber, each comprising a plurality of primary light sources arranged linearly along the strip and configured to each emit in one or more azimuthal directions (or otherwise toward the cylindrical inner surfaces of the chamber). The lighting strips may be curved or bent or warped such that the distance between primary light sources and the light transmissive areas varies. This adds extra dynamism to the resulting light display, by effecting a variation in the size of the visible zones created by each of the light transmissive areas, and so changing the rate at which different transmissive areas appear or disappear from view.

In another example, a substantially spherical device may be provided, wherein the primary light sources are again mounted to a dedicated mounting surface portion provided at a central or middle region of the defined spherical chamber, and arranged to direct light outward toward the spherical boundary of the chamber, through which the light transmissive areas are formed.

Application of the invention is not limited to embodiments comprising regular shaped constructions, such as spherical, cylindrical or cubic shaped outer shells or frames. Rather, the invention may be applied broadly to embodiments comprising inner chambers bound by outer frames or structures of any shape, either regular or irregular. For example, in particular embodiments, the device might comprise an inner chamber bound by an outer surface or shell structure shaped to form a custom 3D shape. The custom 3D shape might for example be modelled on a particular 3D object or 3D object design. Light transmissive areas may be provided at various points through the surface of said outer 3D shape, either in accordance with a regular pattern, or an irregular arrangement.

In examples, the locations of (at least some of) the light transmissive areas might for instance be chosen to coincide with particular features or areas of the custom 3D shape, either (say) to highlight said features, or for instance to avoid highlighting certain other features or portions of the shape.

Primary light sources may in accordance with these embodiments be disposed within the chamber mounted to a mounting surface which itself follows a non-regular shape or contour(s). The mounting surface might for instance be provided having a shape or construction in three dimensions which follows the shape or contours of the outer shell structure itself. Alternatively, the mounting surface may follow a different shape or configuration in three dimensions.

In either case, the primary light sources may be arranged within the chamber so as to direct light at multiple angles toward the inner surface of the outer shell. This may be, in examples, so as to provide light along a plurality of optical axes, each aligned substantially normal with the inner surface of the outer shell. Alternatively, it may be so as to provide light along optical axes forming different angles with the inner surface of the outer shell. This might for example provide a more dynamic, varied or surprising aesthetic effect to observers looking at the outside of the device.

As discussed above, the sparkling effect is maximised when the apparent luminous contrast between illuminated light transmissive areas and surrounding regions of the front panel 20 is sufficiently great. One approach to achieving this is to seek to substantially prevent escape from the chamber 14 of any secondary (for example reflected) light which may have the effect of providing a constant background illumination visible through the holes, which dims the apparent luminosity of primary light sources.

However, an alternative approach is to provide a device comprising one or more light sensor elements arranged in proximity to the outer surface of the front panel 20 and each configured to measure an intensity of light at a region of said outer surface proximal to one of the light transmissive areas. Such an arrangement allows for monitoring of the light level at regions of the front panel surrounding the light transmissive areas. So long as the luminosity of the primary light source is known therefore, the sensor measurements may be used to determine a difference or contrast between the apparent luminosities of the illuminated light transmissive area and the surrounding front panel surface. A feedback system may be further provided allowing for automatic adjustment of the brightness of the respective primary light source in response to a determination that the apparent contrast ratio is too low.

In particular examples for instance, a feedback system may be provided, adapted to maintain a contrast ratio between the apparent luminosity of the illuminated light transmissive area and that of the surrounding front panel surface to within a certain range of values. In particular examples, the feedback system may be configured for instance to maintain said contrast ratio to between 10 and 1000. It is stressed however, that these numbers are provided by way of non-limiting example only, and, as will be appreciated by the skilled person, other contrast ratios might also be employed. In particular, contrast ratios greater than 1000 might be achieved to create an even more aesthetically striking effect.

Choice of primary light source may also be significant in ensuring a sufficiently high contrast between secondary (virtual) light sources and the surrounding surface of the front panel 20. By using LEDs, a high contrast is easier to maintain, since they naturally provide light having very high luminosity.

Additionally, while ensuring that primary light sources are configured to provide light of a luminance sufficient to generate a suitably high contrast ratio (so that the sparkling effect is created), it may also be desirable to maintain the luminance below a certain maximum threshold, in order to avoid discomfort to viewers observing the panel. This may be incorporated within the feedback system described above, or may be achieved simply by limiting the maximum output luminance of individual primary light sources or the primary light sources considered collectively.

For example, it may be calculated, based on the respective arrangements of the light transmissive areas and the primary light sources, the maximum number of primary light sources that may at any one time be visible to any given observer. Based on this, the luminance or optical output of individual primary light sources may be adapted or selected so that said calculated maximum number of primary light sources together does not emit an amount of light that is dangerous or uncomfortable for an observer to view at once.

According to one or more embodiments, one or more of the plurality of primary light sources may be individually addressable. Individually addressable primary light sources may be used to create time-varying illumination effects, e.g. may be configured to follow a particular pattern of time-varying intensity, for instance configured to cyclically dim downwards and upwards, or configured to make discrete stepwise changes in intensity which may or may not be monotonic downwards and/or monotonic upwards. Primary light sources may in examples be configured to switch discretely or between an ON and an OFF state at regular intervals, or to dim cyclically between an OFF state and an ON state of a particular intensity or luminance. In yet another embodiment, the individually addressable primary light sources may be switched on or off according to a random or pseudo-random pattern to enhance the unpredictability of the sparkle effect created with the lighting device.

In another example, the first surface portion is translucent and/or comprises a first plurality of light-transmissive areas, while the second surface portion comprises a second plurality of light-transmissive areas, and a (specularly) reflective inner surface facing towards the first surface portion. In this example, a sparkling effect is provided at a front side of the lighting device and, dependent on the type of reflective inner surface and the translucency of the first surface portion, indirect (diffuse) illumination via a back side of the lighting device or also a sparkling effect.

The first and second surface portions may both have a plurality of light-transmissive areas (such as a plurality of holes) and a reflective inner surface. To provide a sparkling effect at both sides of the lighting device, the reflective inner surfaces must be specularly reflective.

In the aforementioned examples, the primary light sources that are located on the first surface portion are “real” light sources, such as light sources comprising one or more LEDs, and the first surface portion is a mounting surface portion on which the primary light sources are mounted. Alternatively, the primary light sources that are located on the first surface portion may be “virtual” light sources.

Such virtual light sources may be located on a light outcoupling (or light extraction) surface of a light guide. Compared to the examples with “real” primary light sources mounted on a mounting surface portion, this construction represents a more flexible lighting device as it more easily allows an increase in sparkle density and/or change of the sparkle shape.

The light guide panel may be an edge-lit light guide panel having lower and upper opposing major surfaces separated by at least one edge surface, wherein a plurality of LEDs is located adjacent to the edge surface, the plurality of LEDs being arranged to emit light into the light guide panel via the edge surface, and wherein the upper major surface of the light guide panel is a light outcoupling surface.

In a first example of a lighting device according to the invention, wherein the primary light sources that are located on the first surface portion are virtual light sources on a light outcoupling surface of a light guide, the light outcoupling surface of the light guide panel omprises light outcoupling structures to couple light out of the light guide panel. The lighting device further comprises a perforated layer adjacent to the light outcoupling surface of the light guide panel. The perforated layer has a back side facing towards the light outcoupling surface of the light guide panel and an upper side facing away from the light outcoupling surface of the light guide panel. The combination of the light guide panel and the perforated layer is arranged to create a plurality of primary light sources on a first surface portion, wherein the primary light sources are virtual light sources, and wherein the first surface portion is the upper surface of the perforated layer.

The color of the secondary light sources in the upper surface of the perforated layer can be changed by providing a luminescent material in the light outcoupling structures on the light outcoupling surface of the light guide panel. Light outcoupling structures that comprise a luminescent material may also be used to obtain a “color-over-angle” sparkling effect, i.e. a sparkling effect wherein the color varies as a function of the angle of emitted light.

The perforated layer may be a plastic layer or a cardboard layer. The perforated layer may have a white back side facing towards the light outcoupling surface of the light guide panel and a black upper side facing away from the light outcoupling surface of the light guide panel.

In a second example of a lighting device according to the invention, wherein the primary light sources that are located on the first surface portion are virtual light sources on a light outcoupling surface of a light guide, the lower major surface of the light guide panel (i.e. the major surface opposite the light outcoupling surface) comprises a plurality of light outcoupling structures, wherein each of these light outcoupling structures has a specularly reflective surface for reflecting light that is travelling within the light guide in a direction towards the light oucoupling surface of the light guide.

Instead of primary light sources in the form of virtual light sources that are located on a light outcoupling surface of a light guide, virtual primary light sources may also be formed in a different way. For example, real light sources may be provided at the inner surface of the second surface portion, wherein these real light sources are arranged to emit light towards the first surface portion, and wherein the first surface portion has a specularly reflective inner surface, such as a multi-directional specularly reflective inner surface. The plurality of primary light sources located on the first surface portion is then a plurality of virtual primary light sources formed by specular reflections of light emitted by real light sources located on the inner surface of the second surface portion.

In accordance with these or any other embodiments, the second surface portion may comprise dot-shaped (e.g. square, circular, triangular) light-transmissive areas, or may alternatively or additionally comprise linearly extended (straight or curved line) light-transmissive areas. This may provide an additional or alternative light effect.

In one particular example for instance, a diagonal line-shaped virtual primary light source might be located on the first surface portion, and a diagonal line-shaped light-transmissive area on the second surface portion, in optical communication with the diagonal line-shaped virtual primary light source, and formed at an angle (of e.g. 90 degrees) to the primary light source. The effect for an observer moving, for instance, from left to right across the front of the lighting device, is the observation of a sparkle light source which appears to move or glide from a lower region on the lighting device to a higher region on the lighting device (or vice versa) as he walks.

These examples may be used in accordance with (or in combination with) any described embodiment, by making simple substitution of one or more “real” (point) primary light sources with the above described extended or free-form “virtual” primary light sources. Such virtual primary light sources might also be combined with real primary light sources.

In all of the aforementioned examples, the second surface portion may be comprised in a textile or fabric layer, or in a foil. This will result in a lighting device of reduced weight.

Other variations to the disclosed embodiments can be understood and effected by those skilled in the art in practising the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A lighting device for providing a dynamic sparkling or glittering effect,
wherein the lighting device comprises an exposed outer surface and a plurality of primary light sources disposed within a chamber, the chamber having an internal surface arrangement including at least a first surface portion and an opposing second surface portion, the plurality of primary light sources being located on the first surface portion, and the second surface portion comprising a plurality of light-transmissive areas,
wherein each primary light source is arranged to illuminate at least a part of the plurality of light-transmissive areas in order to create a plurality of secondary light sources located on the exposed outer surface of the lighting device, each of the plurality of secondary light sources having a light-emitting surface with an anisotropic luminance, and
wherein each primary light source is adapted to emit light of a particular spectral composition, the internal surface arrangement of the chamber being configured to absorb at least a portion of the spectral composition of the light emitted by the primary light sources onto the surface arrangement other than the light transmissive areas, and
wherein one or more internal surfaces of the chamber are configured to absorb substantially all of the light not falling directly incident on the light transmissive areas.

2. A lighting device as claimed in claim 1, wherein each of the plurality of primary light sources located on the first surface portion comprises a light-emitting diode, and wherein the first surface portion is a mounting surface portion, the plurality of primary light sources being mounted on the mounting surface portion.

3. A lighting device as claimed in claim 1, wherein the first surface portion is adapted to absorb at least a portion of the spectral composition of the light emitted by the primary light sources.

4. A lighting device as claimed in claim 1, wherein the internal surface arrangement is configured to absorb the full spectral composition of the light emitted by the primary light sources.

5. A lighting device as claimed in claim 1, wherein the lighting device comprises at least a first portion of primary light sources adapted to emit light of a first spectral composition, and at least a second portion of primary light sources adapted to emit light of a second spectral composition; and wherein the lighting device further comprises one or more optical elements together adapted to direct light emitted by the at least first portion of primary light sources through the light transmissive areas of the second surface portion at a first range of propagation angles, and to direct light emitted by the at least second portion of primary light sources through the light transmissive areas of the second surface portion at a second range of propagation angles.

6. A lighting device as claimed in claim 5, wherein the optical elements comprise light blocking elements adapted to deflect or absorb at least a portion of the light emitted by the at least first and/or second portion of primary light sources.

7. A lighting device as claimed in claim 5, wherein the at least first portion of primary light sources is arranged at a first distance from the second surface portion, and the at least second portion of primary light sources is arranged at a second distance from the second surface portion, and wherein the optical elements are disposed in-between the first portion of primary light sources and the second portion of primary light sources.

8. A lighting device as claimed in claim 1, wherein one or more of the primary light sources is adapted to individually emit light having a first spectral composition across a first range of propagation angles, and to emit light having a second spectral composition across a second range of propagation angles.

9. A lighting device as claimed in claim 1, wherein the primary light sources each have a respective optical axis, and wherein the light transmissive areas do not lie on any of said respective optical axes.

10. A lighting device as claimed in claim 1, wherein the lighting device further comprises one or more light blocking elements disposed within the chamber, arranged to coincide with and at least partially cover the light transmissive areas of the second surface portion, so as to block the escape of light through the light transmissive areas across one or more ranges of propagation angles.

11. A lighting device as claimed in claim 1, wherein the light transmissive areas are arranged in a first pattern and wherein the plurality of primary light sources are arranged in a second pattern, the second pattern being different to the first pattern.

12. A lighting device as claimed in claim 1, wherein the lighting device further comprises one or more light sensor elements arranged in proximity to the second surface portion and each configured to measure an intensity of light at a region of an outer surface of the second surface portion proximal to one of the light transmissive areas.

13. A lighting device as claimed in claim 1, wherein the second surface portion is curved and/or wherein the primary light sources are arranged at non-uniform distances from the second surface portion.

14. A lighting device as claimed in claim 1, wherein the plurality of primary light sources located on the first surface portion is created by a combination of an edge-lit light guide panel and a perforated layer, the edge-lit light guide panel having a light outcoupling surface, and the perforated layer being adjacent to the light outcoupling surface.

15. A lighting assembly, comprising:
a lighting device as claimed in claim 1; and
a mirror arrangement, configured to intercept light transmitted through one or more of the light transmitting areas of the second surface portion and to reflect it in an alternate direction.
